(19) United States
(12) Patent Application Publication
(10) Pub. No.: US 2010/0053975 A1
(43) Pub. Date: Mar. 4, 2010

(54) Apparatus for Producing a Ring Illumination Pattern

(75) Inventor: Chia-Yu Liu, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 12/512,519

(22) Filed: Jul. 30, 2009

(30) Foreign Application Priority Data
Aug. 27, 2008 (CN) 200810146399.9

(51) Int. Cl. F21V 7/06; F21V 7/08; F21V 7/07

(52) U.S. Cl. 362/296.06; 362/296.08

(57) ABSTRACT

A lighting apparatus for producing a ring illumination pattern, it comprises: a light emitting diode for producing a light beam; and an optical reflective surface for reflecting the light beam to form the ring illumination pattern, wherein the reflective surface can be a hyperboloid, an ellipsoid or a paraboloid.

### BACKGROUND OF THE INVENTION

1. Field of the Invention

The invention relates to a lighting apparatus, and more particularly to an apparatus for producing a ring illumination pattern.

2. Description of the Prior Art

In the former optical elements design such as U.S. Pat. Nos. 4,770,514, 5,485,317, 5,757,557 and 6,819,506, the optical elements are all designed for collimating light beams. The optical elements change the Lambertian distribution of the light beams and increase the illumination efficiency, while the biggest intensity location of the light distribution is still in the central region.

Besides, US Patent Application Publication No. 2007/0091602 disclosed an apparatus for changing the size of the illumination region by superposing several illumination regions. The illumination regions are produced by several light emitting diodes with corresponding optical elements which make the light beam have different light diverging angles, as shown in FIG. 1B and FIG. 1C. From FIG. 1B and FIG. 1C, we can see that the illumination region is superposed by a normal light distribution pattern (bell-shaped) 202, 212 and a ring illumination pattern 204, 214. Therefore, producing a changeable illumination region needs at least a normal light distribution pattern and a ring illumination pattern. However, this patent didn't mention the detailed structure of the optical element for producing the ring illumination pattern. Besides, the optical element of this patent is a transmitting optical element, as shown in FIG. 1A. This kind of optical elements will cause loss of big angle light beams and reduce the efficiency. Therefore, in order to achieve the goal of producing a changeable illumination region without complicated design, the optical element for producing the ring illumination pattern is important. The present provides an apparatus for producing a ring illumination pattern which has higher lighting efficiency.

### SUMMARY OF THE INVENTION

It is the object of the present invention to provide a method for producing a ring illumination pattern, in which, producing different radius of ring illumination pattern by changing the curvature radius or the conic constant.

The present invention provides two kinds of apparatus for producing the ring illumination pattern, which briefly described below. A lighting apparatus for producing a ring illumination pattern, it comprises: a light emitting diode for producing a light beam; and an optical reflective surface for reflecting the light beam to form the ring illumination pattern, wherein the reflective surface can be a hyperboloid, an ellipsoid or a paraboloid. A lighting apparatus for producing a ring illumination pattern, it comprises: a light emitting diode for producing a light beam; an optical unit, it comprises an incident plane, a total reflective plane and an output surface; wherein the light beam enters the incident plane and a first portion of the light beam directly passes through the output surface to form a ring illumination pattern, a second portion of the light beam is total reflected by the total reflective plane to pass the output surface to from the ring illumination pattern.

Moreover, the present invention provides a method for producing a ring illumination pattern, it comprises the following steps: choosing an optical reflective surface, wherein the optical reflective surface is a hyperboloid, an ellipsoid or a paraboloid; defining a conic constant of the optical reflective surface according to the chosen optical reflective surface; and setting a curvature radius corresponding to the optical reflective surface according to the conic constant.

### BRIEF DESCRIPTION OF THE DRAWINGS

Other features and advantages of this invention will become more apparent in the following detailed description of the embodiments of this invention, with reference to the accompanying drawings, in which:

FIGS. 1A, 1B and 1C show a prior art of US Patent Application Publication No. 2007/0091602;

FIGS. 2A, 2B and 2C show a diagram and a table of the first embodiment;

FIGS. 3A, 3B and 3C show a diagram and a table of the second embodiment;

FIG. 4 shows a table of conditions for the second embodiment;

FIGS. 5A, 5B and 5C show a diagram and a table of the third embodiment; and

FIG. 6 shows a diagram of the fourth embodiment.

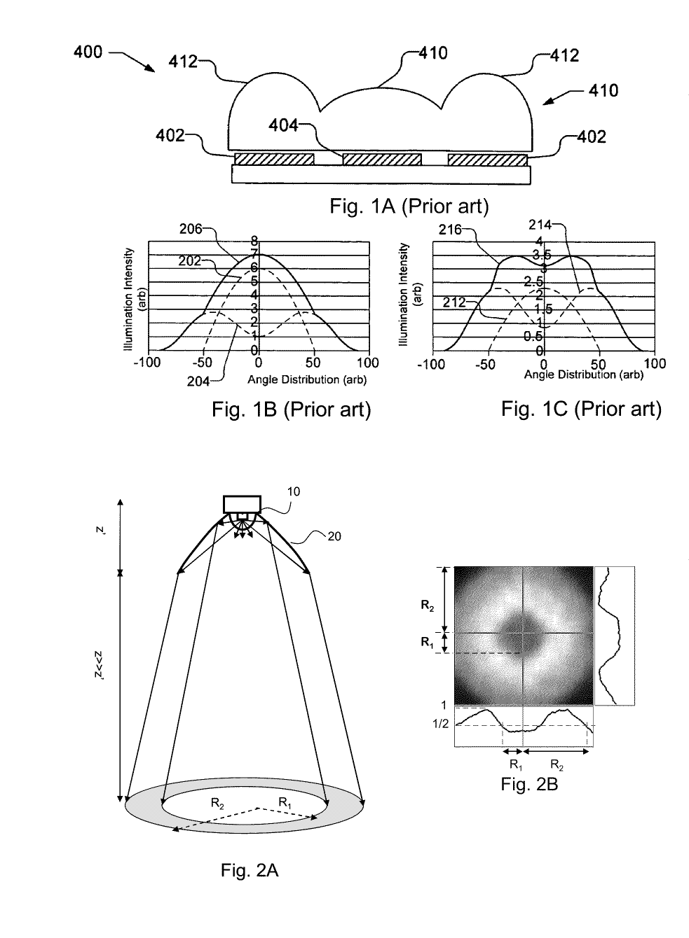

### DETAILED DESCRIPTIONS OF THE PREFERRED EMBODIMENTS

An optical surface can be denoted by the equation

$$x = \frac{{cy}^{2}}{1 + \sqrt{1 - ( 1 + κ ) {c}^{2} {y}^{2}}} + \sum {a}_{i} {y}^{2 i} ,$$

wherein x represents the direction of optical axis, c represents the curvature, κ is the conic constant and aᵢ is the aspheric coefficient. When ignoring the aspheric coefficient, different conic constants κ are corresponding to different curved surfaces. For example, −1<κ<0 represents that the surface is an ellipsoid, κ=−1 represents that the surface is a paraboloid and κ<−1 represents that the surface is a hyperboloid. The invention changes the Lambertian distribution of the light emitting diode to the ring distribution by designing the optical surface to be a reflective surface and by changing the curvature radius to vary the size and the location of the ring illumination pattern.

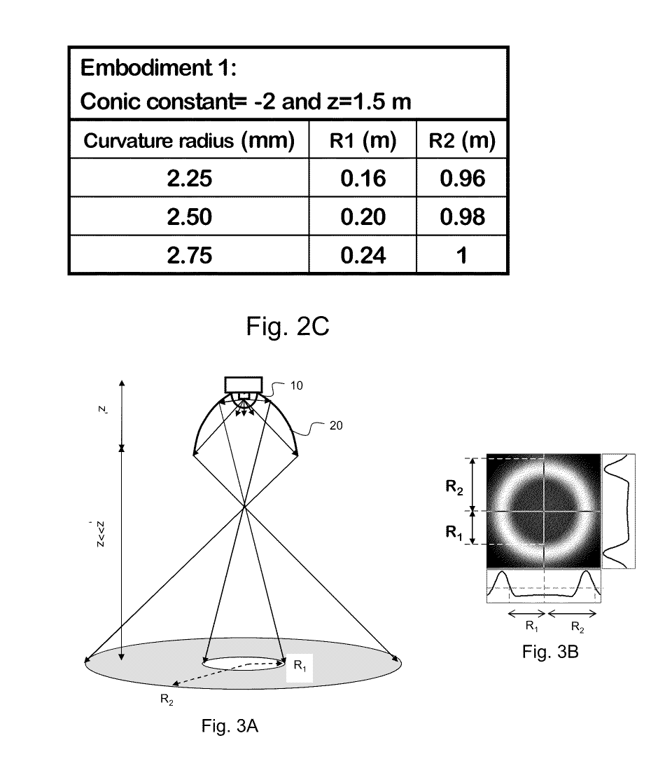

Please refer to FIG. 2A, it shows the first embodiment which the optical surface is a hyperboloid. A portion of the light beams emitting from the light emitting diode 10 are incident to a reflective optical surface 20 which is a hyperboloid and the light beams are reflected by the reflective optical surface 20. The reflected light beams mainly focus on the region between the radius R1 and the radius R2. Due to the light beams of the light emitting diode 10 are diverging, the other portion of light beams that not directly incident to the reflective surface are a rare small portion. Therefore, the light beams located on the region between the central to the radius R1 are rare, and the distribution of the light beams is a ring pattern at the distance Z(1.5 meters) below the light emitting diode 10. The distance Z′ is the distance from the bottom of the light emitting diode 10 to the upper boundary of the optical element, which is the height of the optical element and the light emitting diode 10. Besides, the distance Z′ is quite smaller than the distance Z(1.5 meters), and the distance Z′ can be ignored. Therefore, the actual distance Z+Z′ between the ring illumination pattern and the light emitting diode 10 can be simplified to the distance Z. This definition mentioned above will apply to the below articles.

Please refer to FIG. 2C, the conic constant of the first embodiment is −2. As shown in the table of FIG. 2C, when the curvature radius is 2.25 millimeters, the ring pattern is distributed from R1(0.16 meters) to R2(0.96 meters), wherein the width of the ring pattern is 0.8 meters. When the curvature radius is 2.5 millimeters, the ring pattern is distributed from R1(0.2 meters) to R2(0.98 meters), wherein the width of the ring pattern is 0.78 meters. When the curvature radius is 2.75 millimeters, the ring pattern is distributed from R1(0.24 meters) to R2(1 meters), wherein the width of the ring pattern is 0.76 meters. From the table, by changing the curvature radius of the reflective surface, the size of R1 and R2 are changed. Although there still have light beams enter the region from the center to the R1 and outside the R2, the intensity of the other regions is much lower than the region of R1 to R2. Wherein the definition of the radius R1 and the radius R2 are the distance ranges from the center to the half of the maximum illuminance of the ring pattern, as shown in the lower portion of FIG. 2B.

FIG. 2B is the light intensity distribution diagram of the first embodiment. In the first embodiment, when the curvature radius increases, the ring pattern will expand outwardly from the center. Therefore, we can get the needed ring pattern size and the ring pattern location by changing the curvature radius. From the experimental results, the conic constant is ranges from −3 to −1 and the radius curvature should less than 4.2 millimeters in the first embodiment.

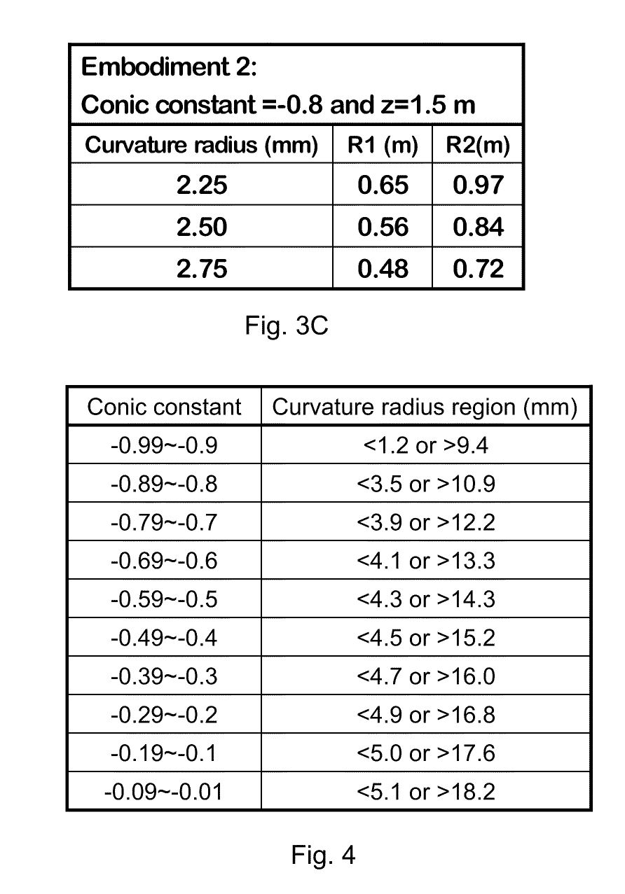

Please refer to FIG. 3A, it shows the second embodiment, wherein the optical surface is an ellipsoid. The light beam produced by the light emitting diode 10 enters to the optical reflective surface of the optical unit. And the reflected light beam will focus on the first focus point and then diverge. Due to the light beam produced by the light emitting diode 10 are divergent, the intensity of the light beam without reflected by the optical reflective surface are weak. Therefore, the light beam focused on the region from the center to the radius R1 are rare and the intensity on the region from the center to the radius R1 are much lower than the region from radius R1 to radius R2. As a result, the light distribution at the distance Z(1.5 meters) below the light emitting diode 10 is a ring pattern, as shown in FIG. 3B. Please refer to FIG. 3C, in the second embodiment, the conic constant is −0.8. When the curvature radius is 2.25 millimeters, the ring pattern is distributed from R1(0.65 meters) to R2(0.97 meters), wherein the width of the ring pattern is 0.32 meters. When the curvature radius is 2.5 millimeters, the ring pattern is distributed from R1(0.56 meters) to R2(0.84 meters), wherein the width of the ring pattern is 0.28 meters. When the curvature radius is 2.75 millimeters, the ring pattern is distributed from R1(0.48 meters) to R2(0.72 meters), wherein the width of the ring pattern is 0.24 meters. Wherein the definition of the first radius R1 and the second radius R2 are the distance ranges from the center to the half of the maximum illuminance of the ring pattern, as shown in the lower portion of FIG. 3B. In the second embodiment, when the curvature radius increases, the ring pattern shrinks toward the center. Therefore, we can get the needed size and location of the ring pattern by changing the curvature radius.

Moreover, different conic constants are corresponding to the range of the curvature radius to form the ring illumination pattern. As shown in FIG. 4, when the conic constant ranges from −0.99 to −0.9, the curvature radius should less than 1.2 millimeters or larger than 9.4 millimeters, then the light beam reflected by the optical surface forms a ring illumination pattern. Therefore, by designing different conic constants and the corresponding curvature radius can change the size and location of the ring illumination pattern.

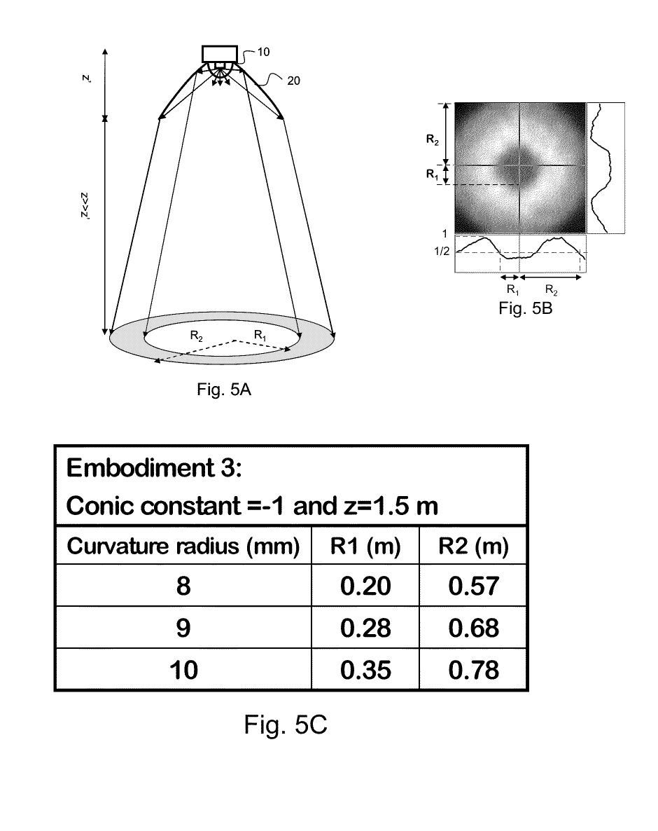

Please refer to FIG. 5A, it show the third embodiment, wherein the optical surface is a paraboloid. A portion of the light beam produced by the light emitting diode 10 enters to the optical reflective surface and then reflected. The reflected light beams center on the region from radius R1 to radius R2. And the other portion of the light beam which without reflected by the optical reflective surface are located on the region from the center to the radius R1 and outside the radius R2. However, due to the light beam produced by the light emitting diode 10 are divergent, the intensity of the other portion of the light beam are weak. Therefore, the reflected light beam forms a ring illumination pattern at the distance Z(1.5 meters) below the light emitting diode 10. Please refer to FIG. 5C, the conic constant of the third embodiment is −1. As shown in the table of FIG. 5C, when the curvature radius is 8 millimeters, the ring pattern is distributed from R1(0.2 meters) to R2(0.57 meters), wherein the width of the ring pattern is 0.37 meters. When the curvature radius is 9 centimeters, the ring pattern is distributed from R1(0.28 meters) to R2(0.68 meters), wherein the width of the ring pattern is 0.4 meters. When the curvature radius is 10 centimeters, the ring pattern is distributed from R1(0.35 meters) to R2(0.78 meters), wherein the width of the ring pattern is 0.43 meters. As mentioned above, we can find that by changing the curvature radius of the reflective surface, the size of the radius R1 and the radius R2 are changed. The intensity of the light beam incident to the region from the center to the radius R1 and outside the radius R2 are much lower than the intensity of the region between the radius R1 and the radius R2. The definition of the first radius R1 and the second radius R2 are the distance ranges from the center to the half of the maximum illuminance of the ring pattern as shown in the lower portion of FIG. 5B.

FIG. 5B shows the light intensity distribution diagram of the third embodiment. In the third embodiment, when the curvature radius increases, the ring pattern will expand outwardly from the center. Therefore, changing the curvature radius can produce the needed size and location of the ring pattern. From the experimental results, the curvature radius should less than 1 millimeter or larger than 7 millimeters in the third embodiment.

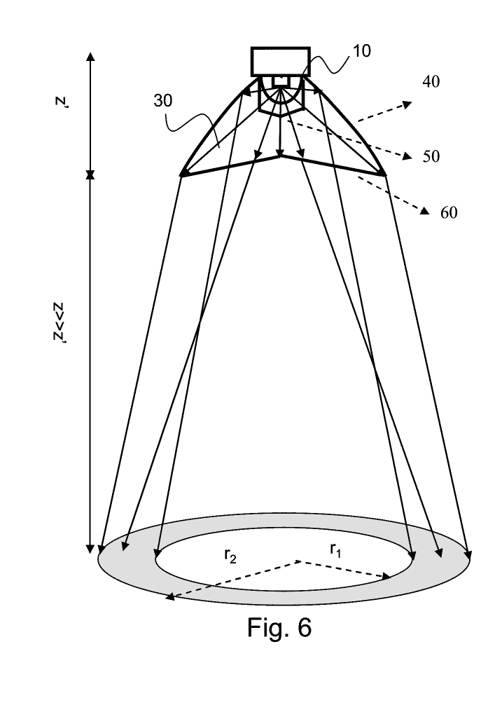

The optical surfaces of the three embodiments mentioned above are reflective surface. Therefore, the parameters can be changed are only the conic constant and the curvature radius. In this embodiment, a total reflective plane 40 of the optical element 30 is used. The total reflective plane 40 can be a hyperboloid, an ellipsoid or a paraboloid. At the same curvature radius and the same conic constant, we can vary the slope or the curvature of the output surface 60 to get different size and location of the ring pattern. As shown in FIG. 6, the light beams produced by the light emitting diode 10 enter the incident plane 50 and enter the optical element 30 made of plastic material. A first portion of the light beam directly passes through the output surface 60. A second portion of the light beam is reflected by the total reflective plane 40, and then outputs from output surface 60. Finally, the light beam projected to the distance 1.5 meters below the light emitting diode 10 is centered on the region between the radius r₁ and the radius r₂. However, there still have light beam incident to the region from the center to the radius r₁. But the intensity of the light beam located on the region from the center to the radius r₁ is much lower than the intensity of the light beam located on the region between the radius r₁ and the radius r₂. Therefore, the output light beam forms a ring illumination pattern. If we design the output surface 60 to be a plane, we can vary the slope or the curvature of the incident plane 50 for guiding the light beam focused on the center to the ring region, which can increase the light efficiency. Moreover, the incident plane 50 and the output surface 60 can be symmetric to an optical axis of the optical element 30. And the symmetric planes and symmetric surfaces are curved or inclined. Besides, the variation of the slope or the curvature radius of the output surface 60 should be changed according to the characteristic of the material for considering the condition of total reflection within the optical element to enhance the efficiency.

Therefore, the present invention provides a method for designing an optical unit for producing a ring illumination pattern. Besides, the present invention provides a small sized optical unit and enhances the optical efficiency.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A lighting apparatus for producing a ring illumination pattern, it comprises:
a light emitting diode for producing a light beam; and
an optical reflective surface for reflecting the light beam to form the ring illumination pattern, wherein the reflective surface can be a hyperboloid, an ellipsoid or a paraboloid.

2. The lighting apparatus for producing a ring illumination pattern according to claim 1, wherein when the optical reflective surface is an ellipsoid, a curvature radius of the optical reflective surface is small than 5.1 millimeters or larger than 9.4 millimeters.

3. The lighting apparatus for producing a ring illumination pattern according to claim 1, wherein when the optical reflective surface is a hyperboloid, a curvature radius of the optical reflective surface is larger than 4.2 millimeters.

4. The lighting apparatus for producing a ring illumination pattern according to claim 1, wherein when the optical reflective surface is a paraboloid, a curvature radius of the optical reflective surface is small than 1 millimeters or larger than 7 millimeters.

5. A method for producing a ring illumination pattern, it comprises the steps:
choosing an optical reflective surface, wherein the optical reflective surface is a hyperboloid, an ellipsoid or a paraboloid;
defining a conic constant of the optical reflective surface according to the chosen optical reflective surface; and
setting a curvature radius corresponding to the optical reflective surface according to the conic constant.

6. A lighting apparatus for producing a ring illumination pattern, it comprises:
a light emitting diode for producing a light beam;
an optical unit, it comprises an incident plane, a total reflective plane and an output surface;
wherein the light beam enters the incident plane and a first portion of the light beam directly passes through the output surface to form a ring illumination pattern, a second portion of the light beam is total reflected by the total reflective plane to pass the output surface to from the ring illumination pattern.

7. The lighting apparatus for producing a ring illumination pattern according to claim 6, wherein the total reflective plane is a hyperboloid, an ellipsoid or a paraboloid.

8. The lighting apparatus for producing a ring illumination pattern according to claim 6, wherein the incident plane is symmetric to an optical axis and the symmetric plane is curved plane or inclined plane.

9. The lighting apparatus for producing a ring illumination pattern according to claim 6, wherein the output surface is symmetric to an optical axis and the symmetric surface is curved surface or inclined surface.
